(19) United States
(12) Patent Application Publication
(10) Pub. No.: US 2026/0115743 A1
(43) Pub. Date: Apr. 30, 2026

(54) HIGH-PRESSURE JET APPARATUS

(71) Applicant: SUGINO MACHINE LIMITED, Namerikawa City (JP)

(72) Inventor: Taiki MATSUI, Namerikawa City (JP)

(21) Appl. No.: 19/357,365

(22) Filed: Oct. 14, 2025

(30) Foreign Application Priority Data
Oct. 24, 2024 (JP) 2024-187607

(51) Int. Cl. B05B 3/02

(52) U.S. Cl. CPC B05B 3/027

(57) ABSTRACT

A high-pressure jet apparatus having a simplified structure includes: a nozzle rotation shaft penetrating a nozzle head, disposed in the nozzle head in a rotatable manner, and including a first flow passage penetrating the nozzle rotation axis; a swivel joint disposed at a proximal end of the nozzle rotation shaft, and connected to the first flow passage; a spindle housing disposed on the nozzle head; a spindle supported by the spindle housing, connected to a distal end of the nozzle rotation shaft, rotatable integrally with the nozzle rotation shaft, and including a flange located at a distal end of the spindle, and a second flow passage penetrating the spindle to be connected to the first flow passage, a nozzle including a first nozzle outlet connected to the second flow passage, and connected to the flange; and a transmission unit that transmits rotation of the nozzle rotation shaft to the spindle.

### CROSS-REFERENCE TO RELATED APPLICATIONS

This application claims the benefit of priority to Japanese Patent Application No. 2024-187607, filed on Oct. 24, 2024, the entire contents of which are hereby incorporated by reference.

### BACKGROUND

### 1. Technical Field

The present invention relates to a high-pressure jet apparatus.

### 2. Description of the Background

A peening apparatus using a high-pressure jet is known (Japanese Patent Application Publication No. 2023-42831, hereinafter referred to as Patent Literature 1). The peening apparatus includes a moving unit and a nozzle head unit that is detachable from the moving unit. The moving unit includes a quill, a first head, and a first spindle. The first head, which includes a mounting hole, is disposed at a distal end of the quill. The first spindle is exposed from the mounting hole. The nozzle head unit includes a second head, a connection shaft, a second spindle, a nozzle, and a swivel joint. The second head includes a connection port connected to the mounting hole. The connection shaft is connected to the first spindle. The nozzle is disposed below the second spindle. The swivel joint, which is disposed at an upper end of the second spindle, is connected to the nozzle.

### BRIEF SUMMARY

The high-pressure jet apparatus disclosed in Patent Literature 1 has a complex structure.

An object of the present invention is to provide a high-pressure jet apparatus having a simplified structure.

A first aspect of the present invention provides a high-pressure jet apparatus, including:
a nozzle head;
a nozzle rotation shaft penetrating the nozzle head, the nozzle rotation shaft disposed in the nozzle head in a rotatable manner about a central axis, the nozzle rotation shaft including a first flow passage extending in an axial direction to penetrate the nozzle rotation axis;
a swivel joint disposed at a proximal end of the nozzle rotation shaft, the swivel joint connected to the first flow passage;
a spindle housing disposed on the nozzle head;
a spindle supported by the spindle housing, the spindle connected to a distal end of the nozzle rotation shaft, the spindle rotatable integrally with the nozzle rotation shaft, the spindle including
   a flange located at a distal end of the spindle, and
   a second flow passage extending in the axial direction, the second flow passage penetrating the spindle to be connected to the first flow passage,
a nozzle including a first nozzle outlet connected to the second flow passage, the nozzle connected to the flange; and
a transmission unit configured to transmit rotation of the nozzle rotation shaft to the spindle.

The high-pressure jet apparatus may be, for example, a cleaning apparatus, a peening apparatus using a high-pressure jet, or a deburring apparatus using a high-pressure jet.

The transmission unit includes an anti-rotation shaft and a receiving portion. The anti-rotation shaft is disposed at a distal end of the nozzle rotation shaft, and the receiving portion is disposed at a proximal end of the spindle. Alternatively, the anti-rotation shaft may be disposed at the proximal end of the spindle, and the receiving portion may be located at the distal end of the nozzle rotation shaft.

The anti-rotation shaft may be, for example, a keyed shaft, a serration shaft, a D-cut shaft, a square head, or a hexagonal head. The receiving portion may be, for example, a key groove, a serration hole, a D-shaped hole, a square hole, a corner groove, or a hexagonal hole. The recess may be, for example, a groove or a hole.

The shaft plane may be arranged rotationally symmetrically about the central axis. For example, the shaft plane may be arranged with twofold or threefold symmetry. The number of receiving surfaces may match the number of shaft planes. Each receiving surface abuts the corresponding shaft plane.

The contact hole is located at a proximal end of the spindle, and the insertion tube is disposed at a distal end of the nozzle rotation shaft. Alternatively, the contact hole may be located at the distal end of the nozzle rotation shaft, and the insertion tube may be disposed at the proximal end of the spindle.

According to the present invention, it is possible to provide a high-pressure jet apparatus with a simplified structure.

### BRIEF DESCRIPTION OF DRAWINGS

FIG. 1 is a cross-sectional view of a high-pressure jet apparatus according to an embodiment.

FIG. 2 is a sectional view taken along line II-II in FIG. 1.

FIG. 3 is an enlarged view of section III in FIG. 1.

### DETAILED DESCRIPTION

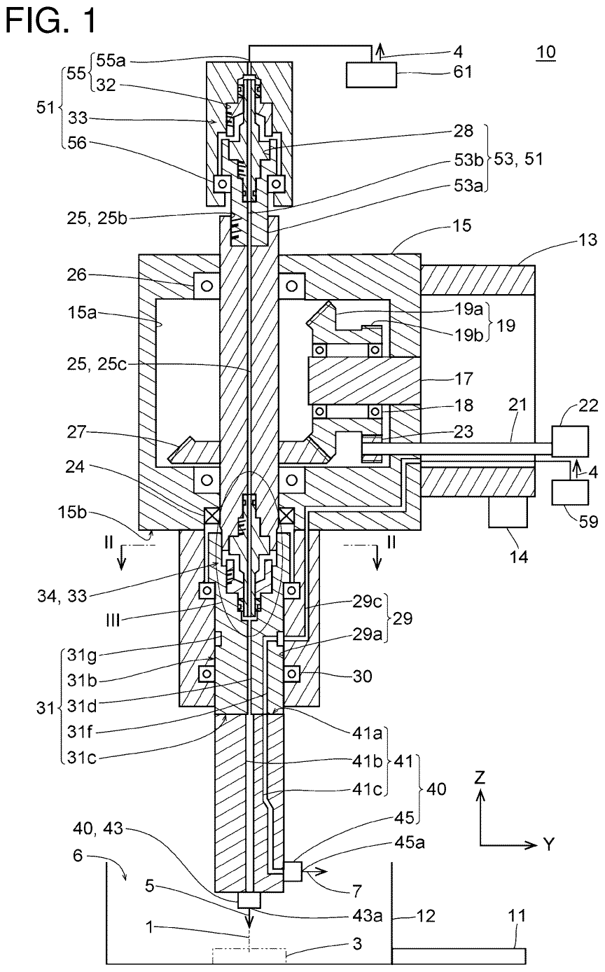

As shown in FIG. 1, a high-pressure jet apparatus (peening apparatus) 10 according to an embodiment includes a frame 11, a processing tank 12, a moving device 14, a quill (feeder) 13, a nozzle head 15, a swivel joint 51, a spindle housing 29, a spindle 31, a transmission unit 34, a nozzle 40, a first pump 61, and a second pump 59.

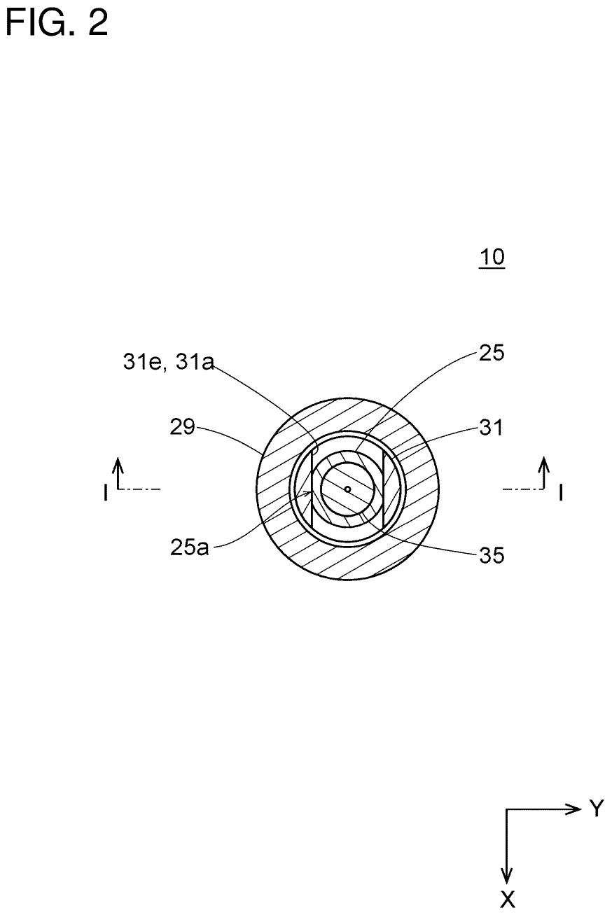

FIG. 1 is a sectional view taken along line I-I in FIG. 2. The line I-I is a YZ plane passing through a central axis 1.

As shown in FIG. 1, the processing tank 12 is disposed on the frame 11. The processing tank 12 stores processing liquid 4 and abrasive material 6. A workpiece 3 is placed in the processing tank 12.

The moving device 14 is disposed on the frame 11. The moving device 14 moves the quill 13 in the lateral direction (X direction), the front-rear direction (Y direction), and the vertical direction (Z direction).

The quill 13, which has a hollow cylindrical shape, extends in the Y direction. The quill 13 is disposed on the moving device 14.

The quill 13 includes a motor 22 and a propeller shaft 21. The motor 22 is disposed at a proximal end (right end in FIG. 1) of the quill 13. The propeller shaft 21, which extends along the quill 13, is disposed inside the quill 13. The propeller shaft 21 is connected to the motor 22.

The nozzle head 15 includes a gear chamber 15a, a lower surface 15b, a nozzle rotation shaft 25, a bearing 26, a fixed shaft 17, a bearing 18, a driving gear 23, an intermediate gear 19, and a second bevel gear (driven gear) 27.

The gear chamber 15a is located inside the nozzle head 15. The lower surface 15b is a flat surface located at a lower end of the nozzle head 15.

The fixed shaft 17, the driving gear 23, the intermediate gear 19, and the second bevel gear 27 are disposed inside the gear chamber 15a.

The driving gear 23 is fixed to a distal end (left end in FIG. 1) of the propeller shaft 21. The driving gear 23 is a spur gear.

The fixed shaft 17, which is fixed to the nozzle head 15, extends in the Y direction.

The intermediate gear 19 is supported by the fixed shaft 17 via the bearing 18. The intermediate gear 19 rotates about the fixed shaft 17. The intermediate gear 19 includes a spur gear 19b and a first bevel gear 19a. The spur gear 19b, which is disposed at a proximal end of the intermediate gear 19, meshes with the driving gear 23. The first bevel gear 19a is connected to the spur gear 19b.

The nozzle rotation shaft 25 passes through the nozzle head 15. The nozzle rotation shaft 25 is supported by the nozzle head 15 via the bearing 26. The nozzle rotation shaft 25 extends along the central axis 1. The central axis 1 extends in the Z direction. The nozzle rotation shaft 25 rotates about the central axis 1. The rotation of the nozzle rotation shaft 25 is transmitted to the spindle 31 via the transmission unit 34.

The second bevel gear 27 is fixed to the nozzle rotation shaft 25. The second bevel gear 27 meshes with the first bevel gear 19a.

The motor 22 rotates the nozzle rotation shaft 25 via the driving gear 23, the intermediate gear 19, and the second bevel gear 27.

As shown in FIGS. 1 to 3, the nozzle rotation shaft 25 includes a shaft plane (anti-rotation shaft) 25a, a connector hole 28, a female thread 25b, and a first flow passage 25c. The shaft plane 25a is located at a distal end (lower end in FIG. 1) of the nozzle rotation shaft 25. The shaft planes 25a, which are parallel to the central axis 1, are symmetrically arranged about the central axis 1. The shaft plane 25a extends from the distal end toward the proximal end of the nozzle rotation shaft 25. The shaft plane 25a protrudes from the lower surface 15b. The connector hole 28, which is located at the distal end of the nozzle rotation shaft 25, extends along the central axis 1. The female thread 25b, which is disposed at a proximal end (upper end in FIG. 1) of the nozzle rotation shaft 25, extends along the central axis 1. The first flow passage 25c, which extends along the central axis 1, connects the female thread 25b and the connector hole 28.

The transmission unit 34 includes a receiving groove (receiving portion) 31e, the shaft plane (anti-rotation shaft) 25a, the connector hole 28, a seal hole 32, and a seal assembly 33.

As shown in FIG. 1, the swivel joint 51 includes a swivel shaft 53, a bearing 56, a swivel housing 55, and the seal assembly 33.

The swivel shaft 53, which is a right cylindrical shape, extends along the central axis 1. The swivel shaft 53 includes a male thread 53a, the connector hole 28, and a flow passage 53b. The male thread 53a is fastened to the female thread 25b. The connector hole 28 is connected to the female thread 25b. The flow passage 53b connects the connector hole 28 and the first flow passage 25c. The swivel housing 55 is supported by the swivel shaft 53 via the bearing 56. The swivel housing 55 includes an inlet 55a and the seal hole 32. The inlet 55a is connected to the seal hole 32. The inlet 55a is connected to the first pump 61. The seal assembly 33 is disposed inside the swivel housing 55.

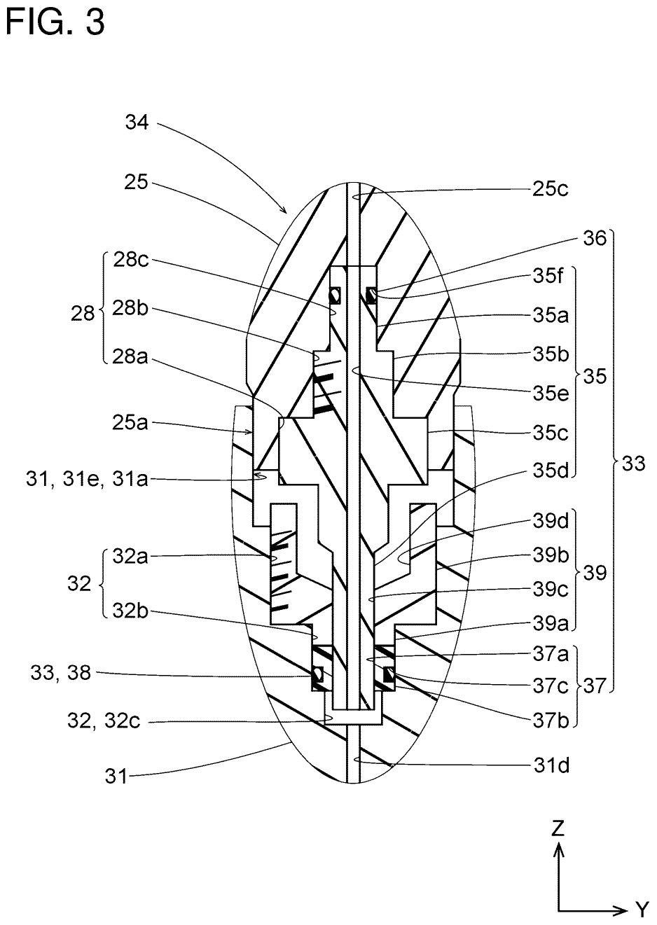

As shown in FIG. 3, the connector hole 28 includes, in order from the opening, a guide hole 28a, a female thread 28b, and a contact hole 28c. The guide hole 28a, the female thread 28b, and the contact hole 28c extend along the central axis 1. The guide hole 28a is a right cylinder. The guide hole 28a has a diameter larger than the female thread 28b. The contact hole 28c is a right cylinder. The contact hole 28c has a diameter smaller than the female thread 28b.

The seal hole 32 includes, in order from the opening, a female thread 32a, a contact hole 32b, and a relief hole 32c. The female thread 32a, the contact hole 32b, and the relief hole 32c extend along the central axis 1. The female thread 32a has an inner diameter larger than the contact hole 32b. The contact hole 32b is a right cylinder. The relief hole 32c is a right cylinder. The relief hole 32c has a diameter smaller than the contact hole 32b.

As shown in FIG. 3, the seal assembly 33 includes a connector 35, a seal retainer 39, a block seal (packing) 37, an O-ring 36, and an O-ring (packing) 38. The connector 35 is fastened to the connector hole 28.

The connector 35 includes, in order, a shaft portion 35a, a male thread 35b, a contact surface 35c, and an insertion tube 35d. The connector 35 also includes an O-ring groove 35f and a connector flow passage 35e. The shaft portion 35a, the O-ring groove 35f, the male thread 35b, the contact surface 35c, the insertion tube 35d, and the connector flow passage 35e extend along the central axis 1. The shaft portion 35a comes into contact with the contact hole 28c.

The O-ring groove 35f is located at the shaft portion 35a. The male thread 35b is fastened to the female thread 28b. The contact surface 35c abuts the guide hole 28a. The contact surface 35c may have a tightening portion (not shown). The tightening portion may be, for example, a square section, a hexagonal section, or parallel surfaces. The insertion tube 35d protrudes from the connector hole 28. The connector flow passage 35e penetrates through the connector 35. The insertion tube 35d, which extends through the seal retainer 39 and the block seal 37, reaches the relief hole 32c.

The O-ring 36, which is mounted in the O-ring groove 35f, seals the gap between the contact hole 28c and the shaft portion 35a.

The block seal 37, which has a hollow cylindrical shape, is mounted in the contact hole 32b. The block seal 37 is made of plastic. The block seal 37 has strength to elastically deform under the pressure of fluid passing through its interior. The block seal 37 has a surface with high lubricity. The block seal 37 may be made of, for example, fluororesin or polyacetal resin.

The block seal 37 includes an inner cylindrical surface 37a, an outer cylindrical surface 37b, and an O-ring groove 37c. The inner cylindrical surface 37a slides in the rotational direction with respect to the insertion tube 35d. The outer cylindrical surface 37b abuts the contact hole 32b. The O-ring groove 37c is located on the outer cylindrical surface 37b. The block seal 37 deforms under the pressure of the fluid, causing the outer cylindrical surface 37b to tightly contact the contact hole 32b and the inner cylindrical surface 37a to tightly contact the insertion tube 35d.

The O-ring 38 is mounted in the O-ring groove 37c. The O-ring 38 seals between the block seal 37 and the contact hole.

The seal retainer 39 has a hollow stepped cylindrical shape. The seal retainer 39 includes a male thread 39b, a pressing portion 39a, a relief hole 39d, and a through hole 39c. The male thread 39b, the pressing portion 39a, the relief hole 39d, and the through hole 39c extend along the central axis 1.

The male thread 39b is fastened to the female thread 32a. The pressing portion 39a is inserted into the contact hole 32b. The pressing portion 39a abuts the contact hole 32b and the block seal 37. The relief hole 39d is located on the near side from the opening of the seal hole 32. The relief hole 39d has an inner diameter larger than the outer diameter of the insertion tube 35d. The through hole 39c penetrates through the seal retainer 39. The through hole 39c has an inner diameter substantially equal to the outer diameter of the insertion tube 35d.

When pressurized fluid flows into the inside of the seal assembly 33, the block seal 37 is pressed in the direction of popping out from the seal hole 32 due to the fluid pressure. The pressing portion 39a presses the block seal 37 to prevent it from coming off.

The spindle housing 29, which has a hollow cylindrical shape, is disposed on the lower surface 15b. The spindle housing 29 extends along the central axis 1. The spindle housing 29 includes a spindle hole 29a and a third flow passage 29c. The spindle hole 29a extends along the central axis 1.

The spindle 31 has a cylindrical shape. The spindle 31 is supported inside the spindle housing 29 via a bearing 30. The spindle 31, which extends along the central axis 1, is connected to a distal end of the nozzle rotation shaft 25. As shown in FIGS. 1 to 3, the spindle 31 includes a receiving groove 31e, a cylindrical surface 31b, a flange 31c, a seal hole 32, a second flow passage 31d, an annular flow passage 31g, and a fourth flow passage 31f.

The receiving groove 31e is located at the upper end of the spindle 31. The receiving groove 31e includes a pair of receiving surfaces (receiving portions) 31a. The receiving surfaces 31a, which are parallel to the central axis 1, are symmetrically arranged with respect to the central axis 1. The receiving surface 31a extends from the proximal end to the distal end of the spindle 31. The receiving surfaces 31a abut the shaft planes 25a, respectively. The cylindrical surface 31b slidably contacts the spindle hole 29a. The flange 31c is located at the distal end face of the spindle 31. The flange 31c includes a pin hole, a key groove, or a bolt hole (not shown) for positioning.

The seal hole 32, which is located at a proximal end of the spindle 31, extends along the central axis 1. The second flow passage 31d, which extends along the central axis 1, penetrates from the seal hole 32 to the flange 31c. The annular flow passage 31g is located on the cylindrical surface 31b. The annular flow passage 31g, which is located between a pair of bearings 30, surrounds the outer periphery of the spindle 31. The spindle 31 is fixed integrally with the spindle housing 29 and the bearing 30 to the nozzle head 15 in a downwardly removable manner.

The third flow passage 29c, which opens to an inner surface of the spindle housing 29, is connected to the annular flow passage 31g. The third flow passage 29c is connected to the second pump 59 via the nozzle head 15 and the quill 13.

The fourth flow passage 31f connects the annular flow passage 31g and the flange 31c.

As shown in FIG. 1, the nozzle 40 includes a nozzle block 41, a first nozzle tip 43, and a second nozzle tip 45.

The first nozzle tip 43 includes a first nozzle outlet 43a. The first nozzle tip 43, which is disposed on a distal end face of the nozzle block 41, ejects a first jet 5 along the central axis 1.

The second nozzle tip 45 includes a second nozzle outlet 45a. The second nozzle tip 45 is disposed on a side surface of a distal portion of the nozzle block 41. The second nozzle tip 45 ejects a second jet 7 in the Y direction.

The nozzle block 41 includes a mounting surface 41a, a fifth flow passage 41b, and a sixth flow passage 41c. The nozzle block 41, which has a cylindrical or polygonal shape (e.g., rectangular prism), extends along the central axis 1. The mounting surface 41a is mounted to the flange 31c with bolts (not shown) or pins (not shown). The fifth flow passage 41b, which opens to the flange 31c, is connected to the second flow passage 31d. The fifth flow passage 41b is connected to the first nozzle outlet 43a. The sixth flow passage 41c, which opens to the flange 31c, is connected to the fourth flow passage 31f. The sixth flow passage 41c is connected to the second nozzle outlet 45a.

The first pump 61 is, for example, a piston pump. The first pump 61 pressurizes processing liquid 4. The processing liquid 4 discharged from the first pump 61 passes through the connector flow passage 35e, the relief hole 32c, the first flow passage 25c, the second flow passage 31d, and the fifth flow passage 41b to be ejected from the first nozzle outlet 43a.

The second pump 59 is, for example, a piston pump. The second pump 59 pressurizes the processing liquid 4. The second pump 59 has a discharge pressure lower than the first pump 61. The processing liquid 4 discharged from the second pump 59 passes through the third flow passage 29c, the annular flow passage 31g, the fourth flow passage 31f, and the sixth flow passage 41c to be ejected from the second nozzle outlet 45a.

The high-pressure jet apparatus 10 according to the present embodiment achieves the following advantageous effects.

The high-pressure jet apparatus 10 includes the first nozzle tip 43 connected to the first pump 61 and the second nozzle tip 45 connected to the second pump 59. Thus, the first jet 5 and the second jet 7 having different pressures can be ejected. Accordingly, different high-pressure jet processes using processing liquids 4 of different pressures can be performed. For example, the first jet 5 having relatively high pressure (e.g., 150 MPa) can perform peening or chipping processes. The second jet 7 having relatively low pressure (e.g., 50 MPa) can perform deburring or cleaning.

The seal assembly 33 seals high-pressure fluid between the insertion tube 35d and the block seal 37 fixed in the seal hole 32. The insertion tube 35d is rotatable relative to the block seal 37. The seal assembly 33 thus can be used as a seal for the swivel joint 51. By incorporating the seal assembly 33 between the nozzle rotation shaft 25 and the spindle 31, a single seal member can serve two sealing points. Thus, the types of maintenance parts can be reduced.

The seal assembly 33 does not have a flange for connecting a nozzle or the like. According to the present embodiment, the nozzle head 15 supports the nozzle rotation shaft 25 and the spindle 31. The seal assembly 33 is supported between the nozzle rotation shaft 25 and the spindle 31. The spindle 31 has the flange 31c at its distal end. This allows the nozzle 40 to be selectively and interchangeably mounted to the spindle 31.

The annular flow passage 31g is located between the spindle 31 and the spindle housing 29. Thus, in addition to the first fluid flow passage passing through the center of the spindle 31, the second fluid flow passage supplied from the outer periphery of the spindle 31 can be arranged. Thus, the two flow passages can be compactly arranged.

The insertion tube 35d is detachable from the block seal 37 and the seal retainer 39. The insertion tube 35d is disposed in the nozzle rotation shaft 25. The block seal 37 is disposed in the spindle 31. In addition, the shaft plane 25a extends from the distal end of the nozzle rotation shaft 25, and the receiving surface 31a extends from the proximal end of the spindle 31. The shaft plane 25a and the receiving surface 31a are parallel to the central axis 1. The receiving surface 31a thus can be pulled out from the shaft plane 25a along the central axis 1. This allows the spindle 31 to be pulled out from the nozzle rotation shaft 25 along the central axis 1.

When abrasive material is mixed into the processing tank 12 as in the peening apparatus of Patent Literature 1, the nozzle 40 or spindle 31 may be easily worn. The spindle 31 of the present embodiment can be pulled out from the nozzle head 15 together with the spindle housing 29 and the nozzle 40. This enables easy maintenance.

The present invention is not limited to the foregoing embodiment, and various modifications may be made without departing from the spirit of the invention. All technical matters included in the scope of the technical ideas described in the claims are encompassed in the present invention. The above embodiment shows a preferred example, but those skilled in the art can derive various alternatives, modifications, variations, or improvements from the contents disclosed herein, and these are included in the technical scope described in the appended claims.

### REFERENCE SIGNS LIST

1 Central axis
10 High-pressure jet apparatus
15 Nozzle head
25 Nozzle rotation shaft
25a Shaft plane (Anti-rotation shaft)
25c First flow passage
29 Spindle housing
31 Spindle
31a Receiving surface (Receiving portion)
31c Flange
31d Second flow passage

What is claimed is:

1. A high-pressure jet apparatus, comprising:
a nozzle head;
a nozzle rotation shaft penetrating the nozzle head, the nozzle rotation shaft disposed in the nozzle head in a rotatable manner about a central axis, the nozzle rotation shaft including a first flow passage extending in an axial direction to penetrate the nozzle rotation axis;
a swivel joint disposed at a proximal end of the nozzle rotation shaft, the swivel joint connected to the first flow passage;
a spindle housing disposed on the nozzle head;
a spindle supported by the spindle housing, the spindle connected to a distal end of the nozzle rotation shaft, the spindle rotatable integrally with the nozzle rotation shaft, the spindle including
a flange located at a distal end of the spindle, and
a second flow passage extending in the axial direction, the second flow passage penetrating the spindle to be connected to the first flow passage,
a nozzle including a first nozzle outlet connected to the second flow passage, the nozzle connected to the flange; and
a transmission unit configured to transmit rotation of the nozzle rotation shaft to the spindle.

2. The high-pressure jet apparatus according to claim 1, wherein
the transmission unit includes
an anti-rotation shaft disposed at a distal end of the nozzle rotation shaft, and
a receiving portion disposed at a proximal end of the spindle, the receiving portion through which the anti-rotation shaft is insertable.

3. The high-pressure jet apparatus according to claim 1, wherein
the transmission unit includes
an anti-rotation shaft disposed at a proximal end of the spindle, and
a receiving portion disposed at a distal end of the nozzle rotation shaft, the receiving portion through which the anti-rotation shaft is insertable.

4. The high-pressure jet apparatus according to claim 1, wherein
the spindle is disposed to the nozzle rotation shaft in a detachable manner integrally with the spindle housing toward a distal end from the nozzle rotation shaft.

5. The high-pressure jet apparatus according to claim 1, wherein
the anti-rotation shaft includes a shaft plane parallel to the central axis, and
the receiving portion is a recess having a receiving surface configured to abut the shaft plane.

6. The high-pressure jet apparatus according to claim 2, wherein
the transmission unit includes
an insertion tube disposed between the nozzle rotation shaft and the spindle, the insertion tube connected to the first flow passage, the insertion tube protruding from a distal end face of the nozzle rotation shaft along the central axis;
a contact hole through which the insertion tube is insertable, the contact hole connected to the second flow passage; and
a packing disposed in the contact hole, the packing configured to seal between the contact hole and the insertion tube.

7. The high-pressure jet apparatus according to claim 1, wherein
the first flow passage is a single passage extending along the central axis, and
the second flow passage is a single passage extending along the central axis.

8. The high-pressure jet apparatus according to claim 1, further comprising:
an annular flow passage located between the spindle and the spindle housing;
a third flow passage located in the spindle housing, the third flow passage connected to the annular flow passage; and
a fourth flow passage located in the spindle, the fourth flow passage opening to the flange, the fourth flow passage connected to the annular flow passage;
wherein the nozzle includes a second nozzle outlet connected to the fourth flow passage.

9. The high-pressure jet apparatus according to claim 2, wherein
the spindle is disposed to the nozzle rotation shaft in a detachable manner integrally with the spindle housing toward a distal end from the nozzle rotation shaft.

10. The high-pressure jet apparatus according to claim 3, wherein
the spindle is disposed to the nozzle rotation shaft in a detachable manner integrally with the spindle housing toward a distal end from the nozzle rotation shaft.

11. The high-pressure jet apparatus according to claim 2, wherein
the anti-rotation shaft includes a shaft plane parallel to the central axis, and
the receiving portion is a recess having a receiving surface configured to abut the shaft plane.

12. The high-pressure jet apparatus according to claim 3, wherein
the anti-rotation shaft includes a shaft plane parallel to the central axis, and
the receiving portion is a recess having a receiving surface configured to abut the shaft plane.

13. The high-pressure jet apparatus according to claim 4, wherein
the anti-rotation shaft includes a shaft plane parallel to the central axis, and
the receiving portion is a recess having a receiving surface configured to abut the shaft plane.

14. The high-pressure jet apparatus according to claim 3, wherein
the transmission unit includes
an insertion tube disposed between the nozzle rotation shaft and the spindle, the insertion tube connected to the first flow passage, the insertion tube protruding from a distal end face of the nozzle rotation shaft along the central axis;
a contact hole through which the insertion tube is insertable, the contact hole connected to the second flow passage; and
a packing disposed in the contact hole, the packing configured to seal between the contact hole and the insertion tube.

15. The high-pressure jet apparatus according to claim 4, wherein
the transmission unit includes
an insertion tube disposed between the nozzle rotation shaft and the spindle, the insertion tube connected to the first flow passage, the insertion tube protruding from a distal end face of the nozzle rotation shaft along the central axis;
a contact hole through which the insertion tube is insertable, the contact hole connected to the second flow passage; and
a packing disposed in the contact hole, the packing configured to seal between the contact hole and the insertion tube.

16. The high-pressure jet apparatus according to claim 5, wherein
the transmission unit includes
an insertion tube disposed between the nozzle rotation shaft and the spindle, the insertion tube connected to the first flow passage, the insertion tube protruding from a distal end face of the nozzle rotation shaft along the central axis;
a contact hole through which the insertion tube is insertable, the contact hole connected to the second flow passage; and
a packing disposed in the contact hole, the packing configured to seal between the contact hole and the insertion tube.

17. The high-pressure jet apparatus according to claim 2, wherein
the first flow passage is a single passage extending along the central axis, and
the second flow passage is a single passage extending along the central axis.

18. The high-pressure jet apparatus according to claim 3, wherein
the first flow passage is a single passage extending along the central axis, and
the second flow passage is a single passage extending along the central axis.

19. The high-pressure jet apparatus according to claim 4, wherein
the first flow passage is a single passage extending along the central axis, and
the second flow passage is a single passage extending along the central axis.

20. The high-pressure jet apparatus according to claim 5, wherein
the first flow passage is a single passage extending along the central axis, and
the second flow passage is a single passage extending along the central axis.
